(19) United States
(12) Patent Application Publication
(10) Pub. No.: US 2003/0017086 A1
(43) Pub. Date: Jan. 23, 2003

(54) Combination of honeycomb body and heat accumulator and method for the operation thereof

(76) Inventors: Rolf Bruck, Bergisch Gladbach (DE); Kait Althofer, Wiehl (DE)

Correspondence Address: LERNER AND GREENBERG, P.A., Post Office Box 2480, Hollywood, FL, 33022-2480, US

(21) Appl. No.: 10/210,980

(22) Filed: Aug. 2, 2002

Related U.S. Application Data
(63) Continuation of application No. PCT/EP01/00868, filed on Jan. 26, 2001.

(30) Foreign Application Priority Data
Feb. 2, 2000 (DE) 100 04 545.6

(51) Int. Cl. B01D 53/34; F01N 3/00; F01N 3/10

(52) U.S. Cl. 422/168; 422/173; 422/198; 422/211

(57) ABSTRACT

A honeycomb body and heat accumulator combination includes a honeycomb body through which an exhaust gas can flow in a preferred flow direction. The honeycomb body has an extent in the preferred flow direction. At least one heat accumulator is disposed inside the honeycomb body. The at least one heat accumulator has a length equal to the extent of the honeycomb body, a given volume and a surface larger than a surface of an individual cylindrical heat accumulator of equal volume. A method for the operation of a honeycomb body is also provided. Such honeycomb body and heat accumulator combinations are particularly useful in exhaust systems where they maintain temperatures necessary for an effective catalytic reduction of pollutants in the exhaust gases over a markedly extended period of time. Cold starting properties of a catalytic converter are thus improved.

### CROSS-REFERENCE TO RELATED APPLICATION

This application is a continuation of copending International Application No. PCT/EP01/00868, filed Jan. 26, 2001, which designated the United States and was not published in English.

### BACKGROUND OF THE INVENTION

Field of the Invention

The invention relates to a combination of a honeycomb body through which an exhaust gas can flow in a preferred flow direction and at least one heat accumulator disposed inside the honeycomb body. The honeycomb body has an extent in the preferred flow direction and the at least one heat accumulator has a given volume. The invention also relates to a method for the operation thereof. Such honeycomb bodies are preferably used in exhaust systems of internal combustion engines, particularly in automobile manufacture.

Existing exhaust systems in automobile manufacture preferably have a catalytic converter, which is intended to reduce pollutant emissions. The catalytic converter is usually constructed as a honeycomb body which is distinguished by the fact that it is constructed for an exhaust gas to flow through it and has a catalytically active surface. Carbon monoxides and hydrocarbons present in the exhaust gas are oxidized through contact between the exhaust gas and the surface of the catalytic converter to form carbon dioxide and water. Furthermore, nitrogen oxides are reduced to nitrogen and oxygen. Those reactions preferably take place at high temperatures. On one hand, if those reactions take place at an ambient temperature in excess of 250° C., known catalytic converters eliminate more than 95% of the carbon monoxides and hydrocarbons in the exhaust gas. At lower temperatures, on the other hand, a distinct increase in pollutant constituents of the exhaust gas may be noted. For that reason, many attempts have been made in the past to reduce the length of time between activation of an internal combustion engine and attainment of optimum catalytic conditions.

Reducing the time before conversion commences can also be achieved by thermally insulating at least components of an exhaust system in such a way that, when the engine is restarted, adequate temperatures for effective pollutant reduction still prevail. To that end, exhaust systems are known, which are equipped with a jacket-like insulation. However, it is only possible to achieve the reaction temperature in a catalytic converter for a very limited period of time. The reason for that is the large area of the jacket-like insulation which is in thermally conductive contact with the much cooler surroundings and therefore leads to cooling. According to a study by the U.S. Environmental Protection Agency (EPA) in 1993, it was established that in 98% of cases restarting of an automobile occurs within 24 hours. That indicates that for a distinct reduction in environmental pollution the exhaust system must be insulated for approximately just such a period of time. It seems at least advisable to achieve a length of time significantly greater than 12 hours, in order to encompass at least those automobiles which serve solely as transportation to the workplace.

U.S. Pat. No. 5,477,676 describes an exhaust system that is intended to maintain the catalytic conditions for as long as possible after deactivation. For that purpose, the exhaust system is enclosed in a vacuum and has heat accumulators, which are intended to retard a cooling of the catalytic converter. In addition to thermal insulation from the radially external surroundings, one embodiment has a heat accumulator in the center of the catalytic converter. That heat accumulator absorbs thermal energy from its surroundings while the exhaust system is in operation and releases it after the exhaust system has been deactivated.

The heat accumulator in the catalytic converter according to U.S. Pat. No. 5,477,676 takes the form of a solid cylinder. It is furthermore proposed that the heat accumulator contain a phase-change material, which is distinguished by the fact that it changes its physical state in an operating temperature range of the catalytic converter. In a temperature range above the melting point, that material absorbs a large amount of thermal energy without its own temperature rising significantly above the melting point. If the surroundings of a heat accumulator of phase-change material are cooler, the heat accumulator begins to give off thermal energy to the surroundings. It must be noted in that case that the thermal conductivity of the phase-change material diminishes with falling temperatures. That may mean that in the case of a cylindrical heat accumulator, the circumferential surface cools rapidly, preventing any transfer of heat from the inside of the heat accumulator to the surroundings.

### SUMMARY OF THE INVENTION

It is accordingly an object of the invention to provide a combination of a honeycomb body and a heat accumulator and a method for the operation thereof, which overcome the hereinafore-mentioned disadvantages of the heretofore-known devices and methods of this general type and which improve cold-starting behavior of a catalytic converter by maintaining operating temperatures for an effective reduction of pollutants in exhaust gas over a significantly longer period of time. The primary focus herein is the configuration and construction of heat accumulators, which will permit an efficient exchange of thermal energy with a surrounding honeycomb body.

With the foregoing and other objects in view there is provided, in accordance with the invention, a honeycomb body and heat accumulator combination, comprising a honeycomb body through which an exhaust gas can flow in a preferred flow direction. The honeycomb body has an extent in the preferred flow direction. At least one heat accumulator is disposed inside the honeycomb body. The at least one heat accumulator has a length equal to the extent of the honeycomb body, a given volume and a surface larger than a surface of an individual cylindrical heat accumulator of equal volume.

Therefore, according to the invention, a honeycomb body has at least one heat accumulator in its interior. The honeycomb body admits a fluid flow in a preferred direction of flow and is particularly suitable as a catalyst substrate for a catalytic converter. The honeycomb body can be described by its extent along the preferred direction of flow of the exhaust gas. At least one heat accumulator has a length, a surface and a predeterminable or given volume. The surface referred to in this case is preferably the circumferential surface. The end surfaces of the heat accumulator point in the direction in which the honeycomb body extends. They are for the most part negligible in extent compared to the circumferential surface and are therefore not relevant to any heat transfer. The predeterminable or given volume always relates to the total number of heat accumulators. If the honeycomb body is constructed with more than one heat accumulator, the individual volumes are added to arrive at the predeterminable or given volume.

According to the concept of the invention, the honeycomb body is constructed in such a way that it has a larger surface than a cylindrical heat accumulator of equal volume and a length equal to the extent of the catalytic converter. A larger surface in relation to the predeterminable or given volume assists the exchange of heat between the heat accumulator and the honeycomb body. Furthermore, the heat accumulator is thereby heated and cooled more uniformly and can consequently store and give off more thermal energy to its surroundings. In this way, any thermal blockage due to low thermal conductivity through rapidly cooled, radially outlying areas can be prevented.

In accordance with another feature of the invention, an increase in the surface-to-volume ratio can be achieved by providing the surface with structuring, at least in parts.

Such structuring can be achieved, for example, in the form of knobs, corrugations or similar elevations on the surface. A surface is preferred which is equal to at least 1.5 times the surface of a cylindrical heat accumulator of the same volume and a length equal to the extent of the honeycomb body.

In accordance with a further feature of the invention, the honeycomb body is constructed with at least two heat accumulators. Dividing a fixed volume between a plurality of heat accumulators also increases the ratio of surface to volume. One major advantage lies in the fact that such heat accumulators are better able to give off the internally stored thermal energy to the surrounding honeycomb body. As a result, the heat accumulators cool off relatively uniformly over a cross-section so that the thermal conductivity is virtually constant over the cross-section.

In accordance with an added feature of the invention, a plurality of heat accumulators are placed in the honeycomb body in such a way that they are spaced at an approximately equal distance from one another. In this way, as the honeycomb body cools, heat is introduced uniformly over a cross-section of the honeycomb body and prevents local cold spots, which lead to an inferior cold-starting behavior of the exhaust system.

In accordance with an additional feature of the invention, the honeycomb body is constructed with at least one locating socket. The at least one locating socket serves for fixing a heat accumulator in the honeycomb body. Constructing the locating socket as a passage is particularly advantageous. In this way it is possible to use heat accumulators which are disposed axially over the entire extent of the honeycomb body and thereby also ensure a uniform heat input over a longitudinal section of the honeycomb body.

In accordance with yet another feature of the invention, the combination is distinguished by the fact that the heat accumulator and the honeycomb body are connected so as to conduct heat. This can be achieved, for example, by pressing the heat accumulator in the honeycomb body. This ensures that an adequate contact area is produced between the heat accumulator and the honeycomb body. A maximum possible contact area assists the exchange of heat.

However, in accordance with yet a further feature of the invention, it is also possible to produce the combination of the heat accumulator and the honeycomb body through the use of a jointed connection. The combination of the heat accumulator and the honeycomb body for an exhaust system, as is preferably used in automobile manufacture, is exposed to high dynamic load stresses. The exhaust system moreover usually has a direct connection to the internal combustion engine. For these reasons it is of particular importance that a permanent connection be made between the heat accumulator and the honeycomb body.

In accordance with yet an added feature of the invention, the heat accumulator is distinguished by a higher mean thermal conductivity per unit area than an equal unit area of the honeycomb body. The term unit area of the heat accumulator is intended to mean an area of specific size on the surface or on a radius in the interior. The thermal conductivity is averaged over the total of all units of area of the heat accumulator. In this way, the effects of material inhomogeneity or especially pronounced temperature fields on the thermal conductivity are eliminated. A high thermal conductivity means that, as it cools, the heat accumulator can release the heat stored therein to the honeycomb body.

The volume of the honeycomb body is made up of a basic structure and voids. The proportion of voids can be expressed as a percentage of the volume of the honeycomb body. A unit volume of the honeycomb body, as used below, is taken to mean a unit volume having a similar percentage of voids to the honeycomb body as a whole.

In accordance with yet an additional feature of the invention, the heat accumulator is constructed with a higher average heat capacity per unit volume than an equal unit volume of the honeycomb body. The heat capacity is averaged over the entire volume of the honeycomb body and the heat accumulator. The greater heat capacity of the heat accumulator means that for a specific temperature variation over time it absorbs or gives off more thermal energy than the honeycomb body. Since the honeycomb body is disposed immediately surrounding the heat accumulator, rapid cooling of the honeycomb body can be prevented.

In accordance with again another feature of the invention, the heat accumulator is made from phase-change material. The phase-change material is distinguished by the fact that a phase change occurs in a temperature range between 250° C. and 600° C., preferably between 350° C. and 500° C. This temperature range is close to an operating temperature of a catalytic converter in an exhaust system. The phase change results in a distinct increase in the heat capacity of the heat accumulator. In normal operation of the catalytic converter, a heat accumulator constructed in this way can therefore absorb a very large amount of thermal energy. As the honeycomb body cools below the phase-change temperature of the heat accumulator, the latter begins to transfer heat to the honeycomb body. The phase-change material must therefore be selected in such a way that the phase-change temperature lies in a temperature range which is required by a honeycomb body for an effective reduction of the pollutants in the exhaust gas.

In accordance with again a further feature of the invention, making the heat accumulator from a phase-change material that is distinguished by a phase change from solid to liquid and liquid to solid is particularly advantageous. Phase-change materials that perform such a phase change in the temperature range cited above are particularly suitable as high-temperature heat accumulators. This type of phase change furthermore permits a very distinct increase in the heat capacity.

In accordance with again an added feature of the invention, the heat accumulator is made from a solid/solid phase-change material. In the case of these materials, the phase change is taken to mean restructuring of the lattice structure. The advantage of such a phase-change material is that, during operation, it remains in a solid state throughout, so that no additional safety precautions need be taken, which would otherwise be necessary in order to maintain the external shape of the heat accumulator under extreme operating conditions.

In accordance with again an additional feature of the invention, the heat accumulator has an annular construction. This means that the heat accumulator has a radially outer surface and a radially inner surface. In this way the heat accumulator gives off heat to radially outer areas and to radially inner areas.

In accordance with still another feature of the invention, the heat accumulator has a strip-shaped construction. The strip-shaped heat accumulator is disposed according to the locating sockets in the honeycomb body. For this purpose it may be necessary for the strip-shaped heat accumulator to be twisted, wound or stacked. A relatively large surface can therefore be achieved for a specific volume.

In accordance with still a further feature of the invention, the heat accumulator has a wire-shaped construction. The term wire-shaped in this context means that the heat accumulator with no twists, windings or stackings has a greater axial length than the axial extent of the honeycomb body. It is possible to place a wire-shaped heat accumulator in a honeycomb body in such a way that, for example, it is disposed like a helix in a corresponding locating socket of the honeycomb body. It is also feasible for the honeycomb body to have a plurality of passages through which a wire-shaped heat accumulator is led. Such an embodiment of the heat accumulator provides a large surface for thermal conduction.

In accordance with still an added feature of the invention, the honeycomb body is formed of metal and has at least partially structured sheet metal layers. The sheet metal layers are produced by stacking and/or winding. This structuring enables an exhaust gas to flow through the honeycomb body. The stacking and/or winding gives the sheet metal layers a specific curve in a cross-section of the honeycomb body perpendicular to a preferred through-flow direction. According to one exemplary embodiment, the heat accumulator is disposed in such a way that it at least partially follows the curve of the sheet metal layers. This permits a combination of the honeycomb body and the heat accumulator, in which the structure of the honeycomb body is not interrupted by holes, grooves etc. and therefore has a particularly stable construction.

In accordance with still an additional feature of the invention, the honeycomb body has partially structured sheet metal layers with winding holes produced by stacking and/or winding. The term winding holes in this context is intended to mean recesses which are produced by twisting the sheet metal layers through the use of a winding mandrel. After winding of the sheet metal layers, the winding mandrels are removed, leaving the aforementioned recesses in the honeycomb body. These winding holes are in the main distinguished by the fact that they are disposed close to an area of the sheet metal layers, which have the smallest radius of curvature. Given the configuration of heat accumulators in these winding holes, it is possible to dispense with the additional formation of locating sockets. At the same time, the stability of the metal sheets is not adversely affected by the subsequent incorporation of locating sockets.

In accordance with another feature of the invention, the-heat accumulator has an electrically heatable construction. This means, for example, that an electrical conductor, which is surrounded by electrical insulation, is disposed on or in the heat accumulator. Fixation for the electrical conductor can be provided by a jointed connection. Alternatively, it is also possible to wrap the heat accumulator with the electrical conductor. In order to prevent cooling of the honeycomb body below a specific temperature, it appears advisable to define a temperature limit which exceeds the temperature range in the cold starting phase and below which the heat accumulator is electrically heated. Defining the temperature limit has the advantage of only placing the power source for the electrical conductor under load when heating of the heat accumulator is necessary.

In accordance with a further feature of the invention, the honeycomb body is constructed with a catalytically active surface. This has the advantage of ensuring that the catalytic reactions take place in an area of the exhaust system, which due to the configuration of the heat accumulator has suitable temperatures for an especially long period of time after deactivation of the exhaust system. The pollutant emission can therefore be reduced or even prevented altogether when the exhaust system is reactivated.

In accordance with an added feature of the invention, the honeycomb body is at least partially enclosed by a casing jacket. The heat accumulator inside the honeycomb body is connected to the casing jacket. The honeycomb body in the main has a very filigree structure and ducts through which exhaust gas can flow. In the context of the high dynamic stressing it seems advisable that the heat accumulator should not be fixed exclusively, if at all, to the filigree structure of the honeycomb body. A durable configuration of the heat accumulator inside the honeycomb body can be achieved by connecting the heat accumulator to the casing jacket.

In accordance with a further feature of the invention, the heat accumulator is connected to the casing jacket through the use of at least one fixing element. These fixing elements are on one hand fixed to the casing jacket and on the other hand serve to fix the heat accumulator in a predefined position. The fixing element may be constructed, for example, as wide-meshed grating outside an end surface of the honeycomb body and may have a plurality of connecting points to the heat accumulator. It is also possible for each heat accumulator to be connected to the casing jacket by a separate fixing element. In addition to fixing the heat accumulator through the use of fixing elements, connected to the end surface of the heat accumulator, the possibility also exists of connecting the fixing elements to the honeycomb body through internal areas of the honeycomb body.

In accordance with an added feature of the invention, at least one fixing element is at least partially composed of a thermal insulation material. In this way it is possible to prevent the thermal energy collected in the heat accumulator from being transmitted through the fixing elements into areas situated outside the honeycomb body. For this purpose the fixing elements may be composed, for example, at least partially of ceramic.

In accordance with an additional feature of the invention, the heat accumulator is connected directly to the casing jacket. In this case the heat accumulator has a connecting area on its surface, which is equal to less than one quarter of its surface area. Consequently, the greater proportion of the surface of the heat accumulator is disposed inside the honeycomb body. This construction is particularly advantageous in connection with one or more strip-shaped heat accumulators, which follow the curve of the sheet metal layers. This allows the heat accumulator to be deformed together with the sheet metal layers and then connected to the casing jacket by a narrow connecting area in the same way as the sheet metal layers. This makes it possible to dispense with additional fixing elements while still achieving the required stability. Additional fixing elements are nevertheless conceivable due to the particularly high stability required of the combination.

In accordance with yet another feature of the invention, the combination is distinguished by the fact that the honeycomb body is divided into different segments by the configuration or shape of at least one heat accumulator. Due to the filigree structure of the honeycomb body it is advisable to construct at least one heat accumulator as a load-bearing element. In the main, this has a larger mass than the honeycomb body, which means that given a dynamic load, relatively large forces act on the connection between the honeycomb body and the heat accumulator. Accordingly, it is advantageous for this combination to be fixed through radially outer areas of the heat accumulator, in an exhaust system, for example. This affords the possibility of locating the honeycomb body in the exhaust system solely by way of a connection to the heat accumulator.

In accordance with yet a further feature of the invention, there is provided a centrally disposed, annular heat accumulator with strip-shaped heat accumulators directed radially outwards like spokes. At the same time, the annular heat accumulator can also be used as a locating socket for the honeycomb structure. The heat accumulators disposed like spokes divide the honeycomb body into segments that are as far as possible approximately equal in size. In this way it is possible to introduce heat very effectively into the honeycomb body. In addition, the radially outer areas of the strip-shaped heat accumulators are connected to a casing jacket, for example. The heat accumulators can be connected to one another thereby increasing the stability of the combination. Manufacturing this configuration of heat accumulators from one piece, that is to say without any supplementary jointing process, is particularly advantageous.

In accordance with yet an added feature of the invention, the construction of the heat accumulator last described is supplemented by a casing jacket, which is also constructed as a heat accumulator. The individual segments are therefore surrounded by heat accumulators and the temperatures needed for a catalytic reaction can be maintained for a long time.

This structure in the form of a cartwheel moreover affords exceptional stability. In particular, the manufacture of such a heat accumulator through jointed connections or where possible from one piece affords advantages with respect to the stability of the combination of the honeycomb body and the heat accumulator.

With the objects of the invention in view, there is also provided a method for the operation of a honeycomb body through which an exhaust gas can flow, which comprises providing the honeycomb body with an extent in a preferred flow direction and providing at least one heat accumulator inside the honeycomb body. The at least one heat accumulator has a given volume, a length equal to the extent of the honeycomb body and a surface larger than a surface of an individual cylindrical heat accumulator of equal volume. Initially, the exhaust gas is led along the at least one heat accumulator in the preferred flow direction, then diverted and finally brought into thermally conductive contact with the at least one heat accumulator in a flow direction opposite to the preferred flow direction.

As mentioned above, the exhaust gas is first led in the preferred direction of flow along a heat accumulator disposed in the inside of the honeycomb body. Exhaust gas is then recirculated, the exhaust gas again being led along the heat accumulator. Due to the catalytic reactions on the catalytically active surface of the honeycomb body, the temperature of the exhaust gas upon first emerging from the honeycomb body may be distinctly higher than upon entering the honeycomb body. The repeated flow of the hotter exhaust gas along the heat accumulator provides it with a greater thermal energy, which the heat accumulator can release again as the honeycomb body cools down.

In accordance with a concomitant mode of the invention, the heat accumulator used in connection with exhaust gas recirculation has an annular construction with a duct. During operation of the exhaust system, the exhaust gas flows in a preferred direction of flow radially outside along the heat accumulator. Upon emerging from the honeycomb body, the exhaust gas is diverted and again led through the duct in the opposite direction. Placing a duct inside the heat accumulator has the advantage of causing the returned exhaust gas to emerge on a restricted area of the end of the honeycomb body and be easily conveyed by suitable devices.

Other features which are considered as characteristic for the invention are set forth in the appended claims.

Although the invention is illustrated and described herein as embodied in a combination of a honeycomb body and a heat accumulator and a method for the operation thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of an embodiment of a honeycomb body with heat accumulators;

FIG. 2A is a perspective view of a further embodiment of a combination of a honeycomb body and a heat accumulator, and

FIGS. 2B and 2C are enlarged views of portions of FIG. 2A;

FIG. 3 is a partly-sectional, perspective view of an embodiment of a honeycomb body;

FIG. 4 is a perspective view of a further embodiment of a honeycomb body with a heat accumulator and measures for heating;

FIG. 5 is a perspective view of a further configuration of a heat accumulator in a honeycomb body;

FIG. 6 is a partly-sectional, end-elevational view of a honeycomb body with a heat accumulator;

FIG. 7 is a perspective view of an embodiment of the honeycomb body indicating a flow pattern of exhaust gas therethrough; and

FIG. 8 is a perspective view of a further embodiment of a honeycomb body with a heat accumulator.

### DESCRIPTION OF THE PREFERRED EMBODIMENTS

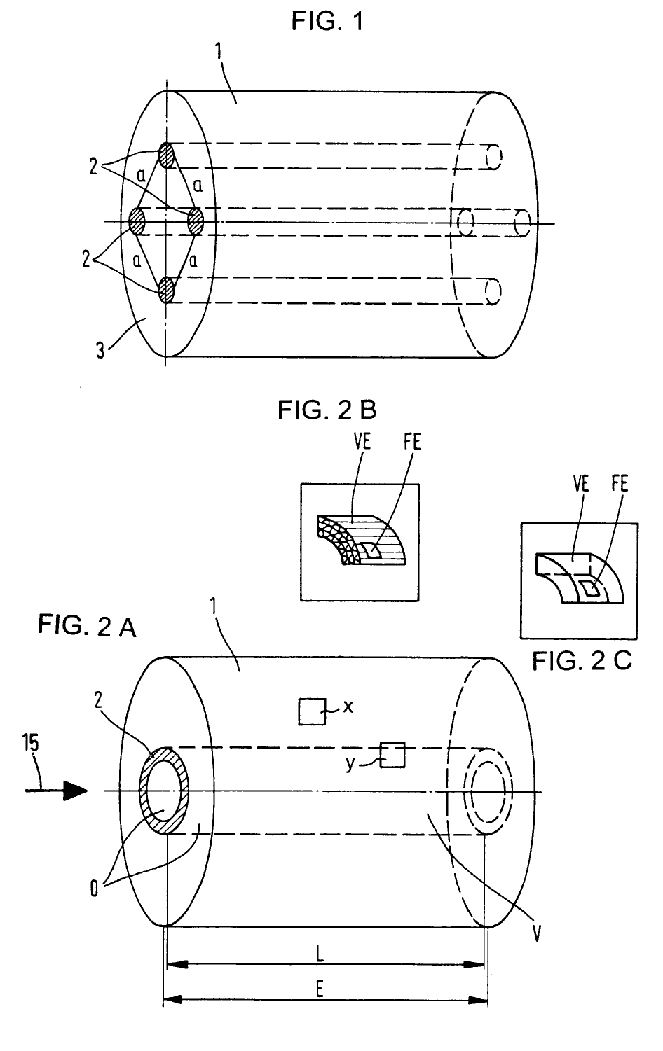

Referring now to the figures of the drawings in detail and first, particularly, to FIG. 1 thereof, there is seen a diagrammatic, perspective representation of a honeycomb body 1, inside of which a plurality of heat accumulators 2 are disposed. The heat accumulators 2 pass through the entire axial extent of the honeycomb body 1. The heat accumulators 2 are uniformly distributed about a cross-section 3 of the honeycomb body 1. Adjacent heat accumulators 2 are spaced at a predeterminable or given distance a from one another, in order to ensure a uniform heat input into the honeycomb body.

FIG. 2A shows an embodiment of a honeycomb body 1 with a heat accumulator 2. A length L of the heat accumulator 2 is equal to an axial extent E of the honeycomb body 1. The heat accumulator 2 is disposed in the center of the honeycomb body 1 and has an annular construction. The annular structural shape means that a surface O is enlarged in comparison to a single cylindrical heat accumulator 2, given a constant volume V. In addition, a volume element VE and a surface area element FE of the honeycomb body 1 are shown in FIG. 2B, which is an enlarged view of a portion x of FIG. 2A. Furthermore, a volume element VE and a surface area element FE of the heat accumulator 2 are shown in FIG. 2C, which is an enlarged view of a portion y of FIG. 2A.

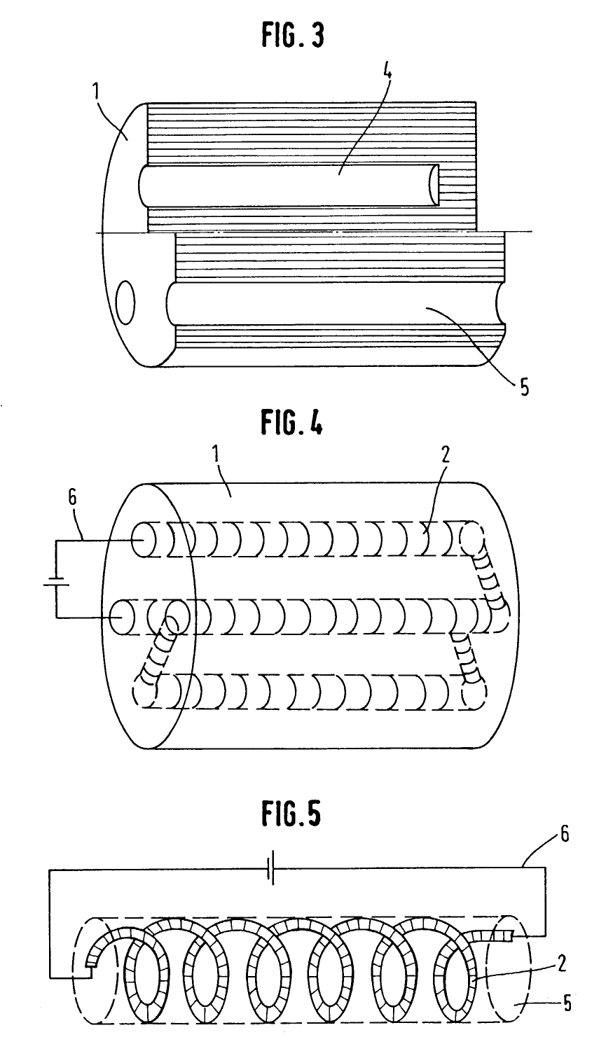

FIG. 3 shows a diagrammatic, perspective representation of a honeycomb body 1, illustrating various possible locating sockets of the honeycomb body 1. A locating socket 4 for a heat accumulator 2 is constructed as a type of bore. This means that the locating socket 4 is not led over the entire axial extent E of the honeycomb body 1. Locating sockets 4 of this type can be disposed in any position relative to the direction of flow.

FIG. 3 furthermore shows a passage 5 as a possible locating socket for a heat accumulator 2. The passage 5 has an advantage in contrast to the locating socket 4, which is that there are no areas of the honeycomb body 1 through which an exhaust gas cannot flow.

A perspective view of a honeycomb body 1 with a wire-shaped heat accumulator 2 is represented in FIG. 4. The wire-shaped heat accumulator 2 has a length L, which is distinctly greater than the axial extent E of the honeycomb body 1. The heat accumulator 2 which is constructed in this way is repeatedly bent and disposed inside the honeycomb body 1. The heat accumulator 2 is provided with an electrical heater 6.

Yet another embodiment of a wire-shaped heat accumulator 2 with an electrical heater 6 is represented in diagrammatic form in FIG. 5. The wire-shaped heat accumulator 2 is helically disposed in a passage 5 of a non-illustrated honeycomb body 1.

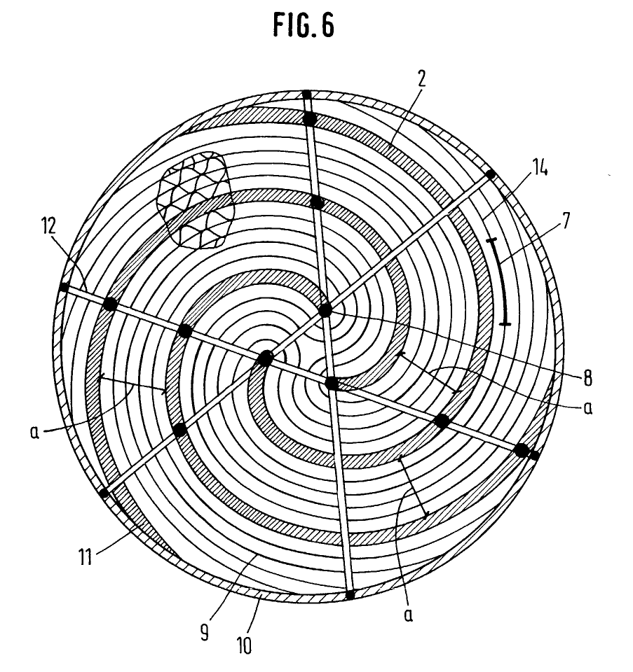

FIG. 6 shows an end view of a further embodiment of a honeycomb body 1 with heat accumulators 2. The honeycomb body 1 has at least partially structured sheet metal layers 14 through which an exhaust gas can flow. The sheet metal layers 14 are produced by winding and/or stacking. The winding of the sheet metal layers 14 in the process of manufacturing the honeycomb body 1 causes the honeycomb body 1 to have winding holes 8. The sheet metal layers 14 of the honeycomb body 1 have a catalytically active surface 9. The sheet metal layers 14 are enclosed by a casing jacket 10.

The strip-shaped heat accumulators 2 follow a curve 7 of the sheet metal layers 14. They are uniformly distributed in the honeycomb body 1 and spaced at a freely selectable distance a from one another.

The illustrated heat accumulators 2 are fixed on one hand to the casing jacket 10 at a connecting area 11. On the other hand, the embodiment shown has fixing elements 12 in order to increase the stability of the combination of the honeycomb body 1 and the heat accumulator 2. The fixing elements 12 have a rod-shaped construction and are fixed to the casing jacket 10. A connection is made between a fixing element 12 and a heat accumulator 2 at points where the fixing elements 12 and the heat accumulators 2 intersect. This increases the stability of the combination of the heat accumulator 2 and the honeycomb body 1.

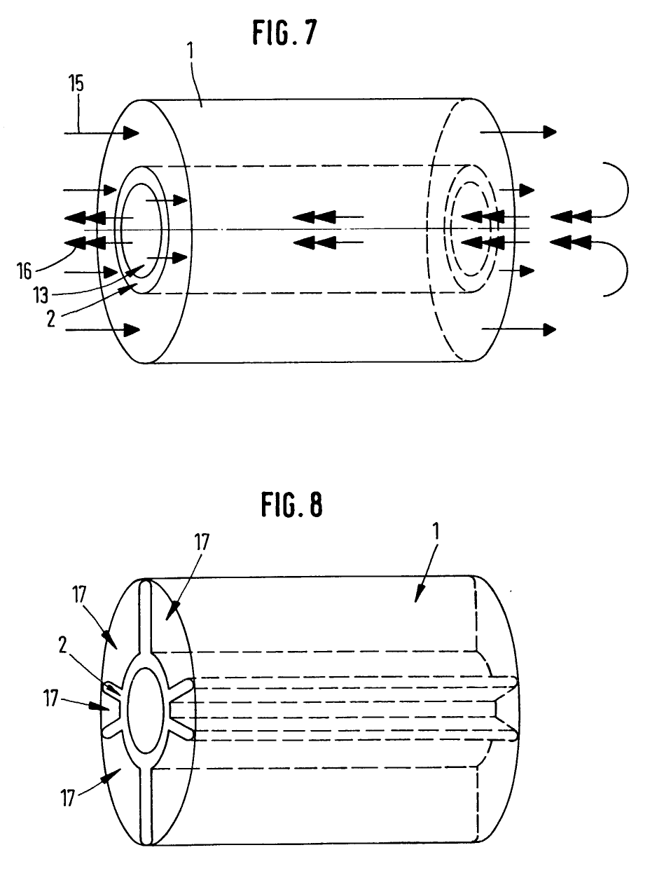

FIG. 7 shows a flow pattern of the exhaust gas provided by a method according to the invention for the operation of a combination of a honeycomb body 1 and a heat accumulator 2. The heat accumulator 2 has an annular construction with a duct 13 and is disposed inside the honeycomb body 1. According to the method described herein, the exhaust gas is first led through the honeycomb body 1 in a preferred direction of flow 15 outside the annular heat accumulator 2. The flow is then reversed by non-illustrated measures. The exhaust gas is then led in the opposite direction 16 through internal areas of the heat accumulator 2 and thereby brought into thermal contact therewith. This makes a particularly large amount of thermal energy available to the heat accumulator 2.

FIG. 8 shows a perspective view of yet another embodiment of a heat accumulator 2 inside a honeycomb body 1. A particularly good heat input into the honeycomb body 1 is achieved in this embodiment, in that the heat accumulator 2 is constructed in the manner of a cartwheel. In this way, the heat accumulator 2 subdivides the honeycomb body 1 into segments 17 of approximately equal size. In addition, such a combination of a heat accumulator 2 and a honeycomb body 1 is particularly stable, even under high dynamic stress loading.

We claim:

1. A honeycomb body and heat accumulator combination, comprising:
a honeycomb body through which an exhaust gas can flow in a preferred flow direction, said honeycomb body having an extent in said preferred flow direction; and
at least one heat accumulator disposed inside said honeycomb body, said at least one heat accumulator having a length equal to said extent of said honeycomb body, a given volume and a surface larger than a surface of an individual cylindrical heat accumulator of equal volume.

2. The combination according to claim 1, wherein said at least one heat accumulator has a surface equal to at least 1.5 times the surface of an individual cylindrical heat accumulator of equal volume and has a length equal to said extent of said honeycomb body.

3. The combination according to claim 1, wherein said at least one heat accumulator is at least two heat accumulators.

4. The combination according to claim 3, wherein said heat accumulators are spaced at an approximately equal distance from one another in said honeycomb body, providing a relatively uniform heat input over a cross-section of said honeycomb body.

5. The combination according to claim 1, wherein said honeycomb body has at least one locating socket receiving at least one heat accumulator.

6. The combination according to claim 5, wherein said at least one locating socket is a passage.

7. The combination according to claim 1, wherein said at least one heat accumulator and said honeycomb body are interconnected to conduct heat.

8. The combination according to claim 1, wherein said at least one heat accumulator and said honeycomb body are connected by a jointed connection.

9. The combination according to claim 1, wherein said at least one heat accumulator has a higher mean thermal conductivity per unit area than an equal unit area of said honeycomb body.

10. The combination according to claim 1, wherein said at least one heat accumulator has a higher mean heat capacity per unit volume than an equal unit volume of said honeycomb body.

11. The combination according to claim 1, wherein said at least one heat accumulator is made of phase-change material in which a phase change occurs in a temperature range between 250° C. and 600° C.

12. The combination according to claim 1, wherein said at least one heat accumulator is made of phase-change material in which a phase change occurs in a temperature range between 350° C. and 500° C.

13. The combination according to claim 11, wherein said at least one heat accumulator is made from a solid-liquid phase-change material.

14. The combination according to claim 11, wherein said at least one heat accumulator is made from a solid-solid phase-change material.

15. The combination according to claim 1, wherein said at least one heat accumulator has an annular construction.

16. The combination according to claim 1, wherein said at least one heat accumulator has a strip-shaped construction.

17. The combination according to claim 1, wherein said at least one heat accumulator has a wire-shaped construction and a length greater than said extent of said honeycomb body.

18. The combination according to claim 1, wherein said honeycomb body is formed of metal and has partially structured sheet metal layers having a curve and being at least one of stacked and wound, and said at least one heat accumulator at least partially follows said curve of said sheet metal layers.

19. The combination according to claim 1, wherein said honeycomb body is formed of metal and has partially structured sheet metal layers being at least one of stacked and wound, said honeycomb body has at least one winding hole, and said at least one winding hole receives said at least one heat accumulator.

20. The combination according to claim 1, wherein said at least one heat accumulator is electrically heatable.

21. The combination according to claim 1, wherein at least parts of said honeycomb body have a catalytically active surface.

22. The combination according to claim 1, which further comprises a casing jacket at least partially enclosing said honeycomb body, said at least one heat accumulator being connected to said casing jacket.

23. The combination according to claim 22, which further comprises at least one fixing element connecting said at least one heat accumulator to said casing jacket.

24. The combination according to claim 23, wherein said at least one fixing element is at least partially formed of a thermal insulation material.

25. The combination according to claim 22, wherein said at least one heat accumulator has a connecting area equal to less than one quarter of said surface of said at least one heat accumulator, and said at least one heat accumulator is directly connected to said casing jacket at said connecting area.

26. The combination according to claim 1, wherein said at least one heat accumulator subdivides said honeycomb body into at least two segments.

27. The combination according to claim 26, wherein said honeycomb body has an inside and an outside, and said at least one heat accumulator is a plurality of heat accumulators extending from said inside towards said outside like spokes.

28. The combination according to claim 27, wherein said heat accumulators are strip-shaped.

29. The combination according to claim 27, which further comprises a casing jacket connected to said at least one heat accumulator, said casing jacket and said at least one heat accumulator being made from the same material.

30. A method for the operation of a honeycomb body through which an exhaust gas can flow, which comprises:
providing the honeycomb body with an extent in a preferred flow direction;
providing at least one heat accumulator inside the honeycomb body, the at least one heat accumulator having a given volume, a length equal to the extent of the honeycomb body and a surface larger than a surface of an individual cylindrical heat accumulator of equal volume; and
initially leading the exhaust gas along the at least one heat accumulator in the preferred flow direction, then diverting the exhaust gas and finally bringing the exhaust gas into thermally conductive contact with the at least one heat accumulator in a flow direction opposite to the preferred flow direction.

31. The method according to claim 30, wherein the at least one heat accumulator has an annular structure defining at least one duct therein, and the method further comprises leading the exhaust gas radially outside and along the at least one heat accumulator in the preferred flow direction and then leading the exhaust gas through the duct in the opposite flow direction.
